(19) United States
(12) Patent Application Publication
(10) Pub. No.: US 2018/0234491 A1
(43) Pub. Date: Aug. 16, 2018

(54) PROGRAM DEPLOYMENT ACCORDING TO SERVER EFFICIENCY RANKINGS

(71) Applicant: HEWLETT PACKARD ENTERPRISE DEVELOPMENT LP, Houston, TX (US)

(72) Inventors: Marcelo GOMES DE OLIVEIRA, Rio Grande do Sul (BR); Airon FONTELES DA SILVA, Rio Grande do Sul (BR); Gustavo BASEGGIO DAS VIRGENS, Rio Grande do Sul (BR)

(21) Appl. No.: 15/751,592

(22) PCT Filed: Aug. 14, 2015
(86) PCT No.: PCT/US2015/045219

§ 371 Date: Feb. 9, 2018

(51) Int. Cl. H04L 29/08; G06F 11/30; G06F 11/34; G06F 8/61; G06F 9/50

(52) U.S. Cl. CPC H04L 67/1002; G06F 11/3006; G06F 9/5083; G06F 8/61; G06F 11/3433; G06F 11/3419

(57) ABSTRACT

In one example, an efficiency rate is determined for each server of a set of servers to be used for deployment of a set of programs. The efficiency rate is determined based upon a measured power consumption by the server during a time period, and based upon a workload of the server during the time period. The workload is determined based upon a count of number of cores of the server utilized and based upon a core performance factor. Each of the servers of the set of servers is ranked with an efficiency ranking based upon the determined efficiency rates. Programs from the set of programs are iteratively deployed to servers of the set of servers in order of efficiency ranking of the servers.

### BACKGROUND

Cloud computing and storage solutions provide users and enterprises with capabilities to store and process their data in third-party data centers. In addition to being shared by multiple users, cloud resources may also be dynamically reallocated per demand. Customers can scale up as computing needs increase and then scale down again as demands decrease.

### DRAWINGS

FIG. 1 is a block diagram depicting an example environment in which various examples of the disclosure may be implemented.

FIG. 2 is a block diagram depicting an example of a system to enable deployment of programs according to server efficiency rankings.

FIG. 3 is a block diagram depicting an example of a memory resource and a processing resource to implement examples of a system to deploy programs utilizing server efficiency rankings.

FIG. 4 illustrates an example of a system to deployment of programs according to server efficiency rankings.

FIG. 5 is a flow diagram depicting implementation of an example of a method to enable deployment of programs according to server efficiency rankings.

FIG. 6 is a flow diagram depicting implementation of an example of a method to enable deployment of programs according to server efficiency rankings, the rankings based upon average efficiency ratings.

FIG. 7 is a flow diagram depicting implementation of an example of a method to enable deployment of programs according to server efficiency rankings, with redeployments of programs according to recalculated efficiency rankings.

### DETAILED DESCRIPTION

### Introduction

Cloud computing solutions provide customers with benefits from economies of scale as the cloud provider seeks to maximize the effectiveness of the shared resources. One way cloud service providers can leverage economies of scale and reduce customer costs and environmental impact is to seek to employ the most energy efficient servers to host the provided programs. However, given the heterogeneous nature of the hardware of a cloud systems and the frequent reallocation of resources, it can be a difficult task for cloud providers to determine the most energy efficient servers available for deployment at a given moment. For instance in addition to having multiple types of servers, similar severs can have significantly different numbers of cores and core configurations. Cloud service providers and their users will thus appreciate a system and method to automatically and effectively deploy programs among a set of heterogeneous servers in a manner that maximizes energy efficiencies of the servers set.

To address these issues, various examples described in more detail below provide a system and a method for deploying programs among servers according to determined efficiency rankings for the servers. In examples, an efficiency rate is determined for each server of a set of servers to be used for deployment of a set of programs. The efficiency rate for each server is determined based upon a measured power consumption by the server during a time period, and a workload of the server during the time period. The workload is determined based upon a count of number of cores of the server then utilized, and upon a core performance factor.

In examples, a core performance factor for each server of the set of servers may be determined based upon published performance indexes for the server and based upon a number of cores included within the server. In examples, the published performance index for the server and the number of cores included within the server may be values obtained from a manufacturer website, a provider website, or a technology news website. Following determination of the efficiency rates, each server of the set of servers is ranked with an efficiency ranking based upon the efficiency rates. Programs from the set of programs are then iteratively deployed to the set of servers in order of efficiency ranking of the servers.

In this manner, the disclosed examples provide an effective and efficient system and method to enable automated and power consumption-efficient deployment of programs across a set of servers. Cloud solution providers, program providers, enterprise users and end users should each appreciate reduced costs and reduced environmental impacts to be enjoyed with utilization of the disclosed examples.

The following description is broken into sections. The first, labeled “Environment,” describes an environment in which various examples may be implemented. The second section, labeled “Components,” describes examples of various physical and logical components for implementing various examples. The third section, labeled “Illustrative Example,” presents an example of program deployment according to server efficiency rankings. The fourth section, labeled “Operation,” describes implementation of various examples.

Environment:

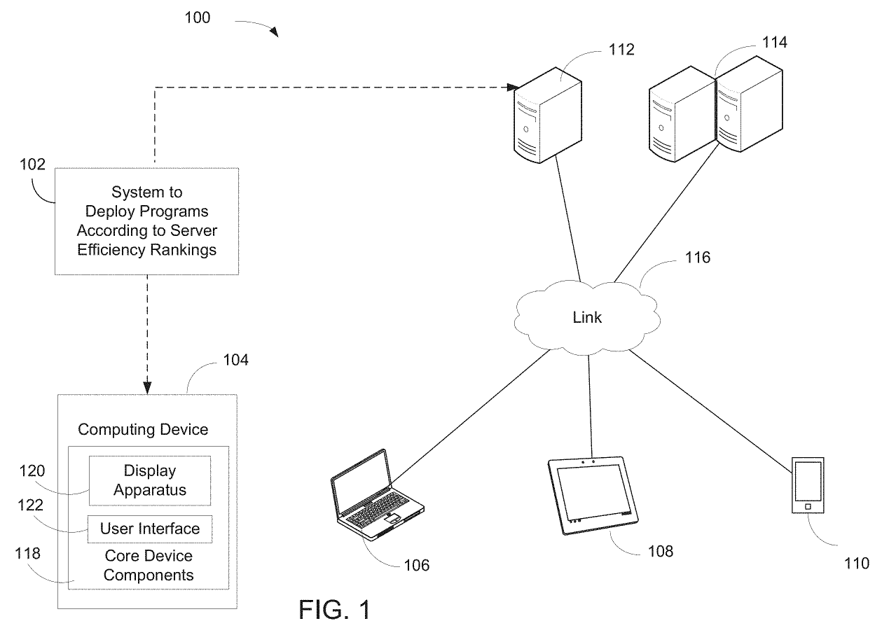

FIG. 1 depicts an example environment 100 in which examples may be implemented as a system 102 for program deployment according to server efficiency rankings. Environment 100 is shown to include computing device 104, client devices 106, 108, and 110, server device 112, and server devices 114. Components 104-114 are interconnected via link 116.

Link 116 represents generally an infrastructure or combination of infrastructures to enable an electronic connection, wireless connection, other connection, or combination thereof, to enable data communication between components 104-114. Such infrastructure or infrastructures may include, but are not limited to, a cable, wireless, fiber optic, or remote connections via telecommunication link, an infrared link, or a radio frequency link. For example, link 116 may represent the internet, intranets, and intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 106, 108, and 110 represent generally a computing device with which a user may interact to communicate with other client devices, server device 112, and/or server devices 114 via link 116. Server device 112 represents generally a computing device to serve a program and corresponding data for consumption by components 104-110 and 114. Server devices 114 represent generally a group of computing devices collectively to serve a program and corresponding data for consumption by components 104-110 and 112.

Computing device 104 represents generally a computing device with which a user may interact to communicate with client devices 106-110, server device 112, and/or server devices 114 via link 116. Computing device 104 is shown to include core device components 118. Core device components 118 represent generally the hardware and programming for providing the computing functions for which device 104 is designed. Such hardware can include a processor and memory, a display apparatus 120, and a user interface 122. The programming can include an operating system and applications. Display apparatus 120 represents generally a combination of hardware and programming to exhibit or present a message, image, view, or other presentation for perception by a user, and can include, but is not limited to, a visual, tactile or auditory display. In examples, the display apparatus 120 may be or include a monitor, a touchscreen, a projection device, a touch/sensory display device, or a speaker. User interface 122 represents generally a combination of hardware and programming to enable interaction between a user and device 104 such that the user may effect operation or control of device 104. In examples, user interface 122 may be, or include, a keyboard, keypad, or a mouse. In some examples, the functionality of display apparatus 120 and user interface 122 may be combined, as in the case of a touchscreen apparatus that may enable presentation of images at device 104, and that also may enable a user to operate or control functionality of device 104.

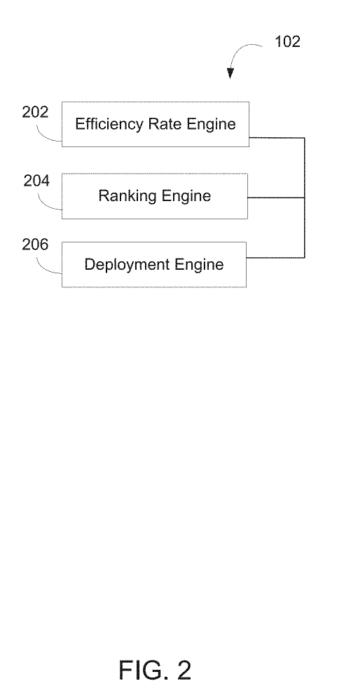

System 102, discussed in more detail below, represents generally a combination of hardware and programming to enable deployment of programs according to determined server efficiency rankings. In some examples, system 102 may be wholly integrated within core device components 118. In other examples, system 102 may be implemented as a component of computing device 104, client devices 106-110, server device 112, or server devices 114 where it may take action based in part on data received from core device components 118 via link 116. In other examples, system 102 may be distributed across computing device 104, client devices 106-110, server device 112, or server devices 114. For example, components that implement efficiency rate engine 202 (FIG. 2) functionality of

determining an efficiency rate for each server of a set of servers to be used for deployment of a set of programs, and ranking engine 204 (FIG. 2) functionality of ranking each of the servers of the set of servers with an efficiency ranking based upon the determined efficiency rates, may be included within computing device 104. Continuing with this example, components that implement deployment engine 206 (FIG. 2) functionality of iteratively deploying programs from the set of programs to a set of available servers in order of efficiency ranking of the servers until the set of programs is deployed may be components included within a server device 112. Other distributions of system 102 across computing device 104, client devices 106-110, server device 112, and server devices 114 are possible and contemplated by this disclosure. It is noted that all or portions of system 102 to enable deployment of programs according to determined server efficiency rankings may also be included on client devices 106, 108 or 110.

Components:

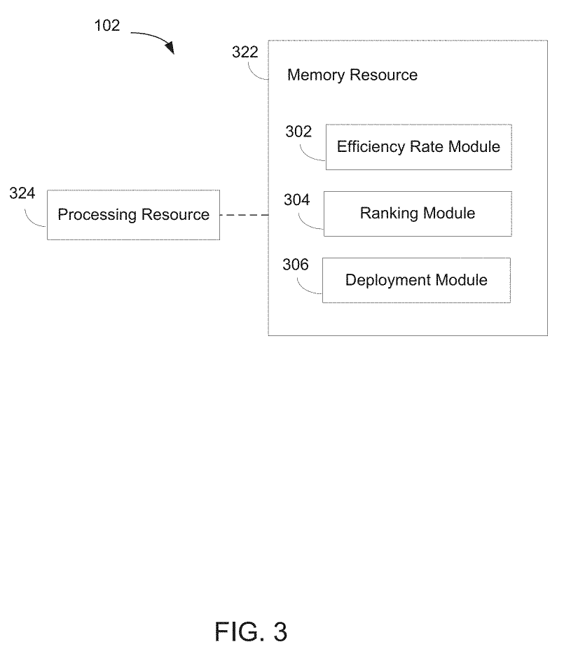

FIGS. 2 and 3 depict examples of physical and logical components for implementing various examples. In FIG. 2 various components are identified as engines 202, 204, and 206. In describing engines 202-206 focus is on each engine's designated function. However, the term engine, as used herein, refers generally to a combination of hardware and programming to perform a designated function. As is illustrated later with respect to FIG. 3, the hardware of each engine, for example, may include one or both of a processor and a memory, while the programming may be code stored on that memory and executable by the processor to perform the designated function.

FIG. 2 is a block diagram depicting components of a system 102 to enable deployment of programs across a set of servers according to determined server efficiency rankings. In this example, system 102 includes efficiency rate engine 202, ranking engine 204, and deployment engine 206. In performing their respective functions, engines 202-206 may access a data repository, e.g., a memory accessible to system 102 that can be used to store and retrieve data.

In the example of FIG. 2, efficiency rate engine 202 represents generally a combination of hardware and programming to determine an efficiency rate for each server of a set of servers, the servers to be used for deployment of a set of programs. As used herein, an “efficiency rate” refers generally to a ranking, score, grade, value, or other assessment of efficiency that includes, but is not limited to, a numerical rating. As used in herein a “server” refers generally to any computing device that hosts a program that provides a service to a client. In examples, a server may be a computer networking device, chip set, a desktop computer, a workstation, a mobile computing device, or another processing device or processing equipment. As used herein, a “client” refers to a computer device or a program that accesses a service made available by a server. As used herein, a “program” refer generally to an operating system, an application, or other computer code or computer instructions for execution at a computing device. In examples the client program may execute on a computing device that is distinct from the server, with communication between the server program and the client program occurring over a network (e.g., link 116). Examples of services that may be provided by a server include, but are not limited to, a database service served by a database server program, a file service served by a file server program, a mail service served by a mail server program, a print service served by a print server program, a web service served by a web server program, a gaming service served by a gaming server program, an operating system service served by an operating system server program, and an application service served by an application server program.

Continuing at FIG. 2, in examples, efficiency rate engine 202 is to determine the efficiency rate for each of the servers of the server set based upon a measurement of power consumed by the server during a time period and a workload of the server during the time period. In examples, a measurement of power consumed may be in units of, but is not limited to, joules, watts, or kilowatts. As used herein, a “time period” is used synonymously with “timeframe” and refers generally to a space of time (e.g., a nanoseconds, a microsecond, a millisecond, a second, a minute, etc.), e.g., a space of time with an established beginning time and ending time.

As used herein, a “workload” of a server refers generally to a determined level of server utilization or performance. Efficiency rate engine 202 is to determine the workload for each of the servers of the server set based upon a count of number of cores of the server being utilized and based upon a core performance factor. As used herein, a “core” refers generally to an execution unit of a physical processor, wherein the execution unit is capable of reading and execute central processing unit (CPU) instructions and operating independently with respect to cache, memory management, and/or input/output (I/O) ports. In examples, the physical processor includes multiple execution units. In examples, an individual core in a multiple core processor may execute multiple instructions at the same time, increasing the overall speed for programs compatible with parallel processing. In examples, multiple cores may be integrated onto a single semiconductor wafer, or onto multiple semiconductor wafers within a single IC (integrated circuit) package. In examples, efficiency rate module 202 may cause the count of the cores being utilized. In other examples, efficiency rate module 202 may obtain, e.g., from another computing device or application, data indicative of the count of cores being utilized, wherein the count was caused or performed by the another computing device or application. In examples, the count of number of cores of the server being utilized is a count of utilized cores made at the same time the power consumption measurement was made. In other examples, the count of number of cores of the server being utilized is a count of utilized cores made within a defined time proximity of the time that the power consumption measurement was made (e.g., within x nanoseconds, microseconds, milliseconds, etc. of the time that the power consumption measurement was made).

Continuing at FIG. 2, as used herein, a “core performance factor” refers generally to a number, quantity, or value that is indicative of a feature, trait, quality, characteristic, or usage of the core. In examples, efficiency rate module 202 may obtain a core performance factor for a server from a website of a manufacturer of the server, a website of a distributor or other provider of the server, or a technology news website. As used herein a “technology news website” refers generally to a website at which news is provided relative to computer programming, applications, computer hardware, and/or computer networks.

In examples, efficiency rate module 202 may determine the core performance factor for a subject server of the set of servers, or for each server of the set of servers. In examples, efficiency rate module 202 may determine the core performance factor for a subject server, or for each server of the set of servers, based upon a published performance index for the server and a number of cores included within the server. As used herein “published” refers generally to an item having been disseminated or made available in an electronic format, so as to be obtainable by a computing device or program. As used herein a “published performance index” for a server refers generally to a published expression or value that is indicative of performance of a server relative or server model. For instance, in an example performance index construct a server that has been assigned a published performance score of “426” may be viewed as having a higher performance than a second server that has been assigned a published performance score of “269.” In another example performance index construct a subject server of a server model that has been assigned a published performance score of “1.45” may be viewed as having a higher performance than a second subject server of a second server model that has been assigned a performance score of “0.98”, where a performance score of “1.00” is an average performance. Other performance index constructs are possible and are contemplated by this disclosure.

Continuing at FIG. 2, in examples, efficiency rate module 202 may cause the count of the cores included within a subject server of the set of servers, or within each of the servers of the set of servers. In other examples, efficiency rate module 202 may obtain data indicative of a count of cores included within a subject server of the set of servers, or within each of the servers of the set of servers, from a website such as a manufacturer website, a provider website, or a technology news website. In an example, the manufacturer website, a provider website, or a technology news website may include data relative to a model corresponding to the subject server of the set of servers, or corresponding to each of the servers of the set of servers.

In another example, the manufacturer website, a provider website, or a technology news website may include data relative to a model corresponding to the subject server of the set of servers itself (e.g., according to a serial number), or corresponding to each of the servers of the set of servers themselves (e.g., according to serial numbers). In yet another examples, efficiency rate module 202 may obtain data indicative of a count of cores included within a subject server of the set of servers, or within each of the servers of the set of servers, from the server itself, via a network (e.g., link 116).

In examples, efficiency rate engine 202 is to determine the efficiency rate for each server of the set of servers at time or during a period that the server is being used for deployment of a program. In this manner, the determined efficiency rate will accurately reflect productive or actual usage of the servers, as opposed to reflecting usage that includes server idle or server down times.

Continuing at FIG. 2, in a particular example, efficiency rate engine 202 may determine an efficiency rate E(x) for each server of the set of servers utilizing the following formula:

$$E ( x ) = \frac{Px}{Wx}$$

where Px is the measured power consumption by server x during a given time period, and Wx is the workload of the server x during the time period, the workload determined based upon a count of number of cores of server x utilized and upon a core performance factor. In an particular example, the workload for server may be determined according to a formula

Wx=count of number of cores utilized(x)*core performance factor(x)

wherein the core performance factor for server x may be determined according to a formula

$$core performance factor ( x ) = \frac{published performance index ( x )}{number of cores included ( x )} .$$

In this particular example, the published performance index (x) and the number of cores included(x) may be values obtained from a manufacturer website, a provider website, or a technology news website.

Continuing at FIG. 2, in another example, efficiency rate engine 202 may determine an efficiency rate E(x) for each server of the set of servers utilizing the following formula:

$$E ( x ) = \frac{{\sum }_{1}^{t} Px}{{\sum }_{1}^{t} Wx}$$

where E(x) is an average efficiency rate for servers x over a given time period, with E(x) determined by a formula including a fraction wherein the numerator includes a sum of t measurements of power consumption Px by server x during a given time period and the denominator includes a sum of t instances of workload Wx by server x during the time period. In an example, workload Wx is determined in each instance utilizing a formula

W(x)=count of number of cores utilized(x)*core performance factor(x).

In examples, core performance factor (x) may be determined utilizing published performance index (x) and number of cores included (x) values obtained from a manufacturer website, a provider website, or a technology news website.

Continuing with the example of FIG. 2, ranking engine 204 represents generally a combination of hardware and programming to rank each of the servers of the set of servers with an efficiency ranking. As used herein, an “efficiency ranking” refers generally to an order, grade, or other assessment of efficiency of a server that may include, but is not limited to, a numerical rating or an alphabetical rating. Ranking engine 204 determines the efficiency rankings based upon the efficiency rates that were determined by efficiency rate engine 202. For instance, utilizing an efficiency rate model wherein a first server with a determined efficiency rate of “444” is indicative of a higher power consumption efficiency than a second server that has a determined efficiency rate of “220”, ranking engine 204 may assign an efficiency ranking to the first server such as “Rank 1”, “First Rank”, or “Rank A”, or the like and may assign an efficiency ranking to the second server such as “Rank 2”, “Second Rank”, “Rank B”, or the like according to a given efficiency ranking construct. Other efficiency ranking constructs are possible and are contemplated by this disclosure.

Continuing with the example of FIG. 2, deployment engine 206 represents generally a combination of hardware and programming to iteratively deploy programs from the set of programs to a set of available servers in order of efficiency ranking of the servers. As used herein, to “deploy” a program to a server refers generally to cause an execution of the program at a server. In examples, deployment of a program will also include an installation of the program at a server. In examples, deployment engine 206 is to iteratively deploy programs from the set of programs to servers of the set of servers in order of the efficiency ranking of the servers until each of the programs of the set of programs is deployed. As used herein, to “iteratively deploy” a set of programs refers generally to repeatedly or consecutively deploy programs from the set, one program after another program. In an example, wherein a first server has a ranking of “Rank 1”, “First Rank”, or “Rank A”, or the like and a second server has a ranking such as “Rank 2”, “Second Rank”, “Rank B”, or the like, deployment engine 206 may deploy programs to the highest ranking sever until the highest ranking server is at maximum capacity, and then may deploy programs from the set of programs to the server with the next highest efficiency ranking, and so on. In examples, the deployment of program from the set of programs to the server with the highest efficiency ranking is a deployment of one program at a time.

In examples, deployment engine 206 may, responsive to obtaining data indicative that a first server from the set of available servers is at or is in excess of a program capacity, remove the first server from the set of available servers. In this example, deployment engine 206 has caused the first server to no longer be considered in the comparison of servers according to efficiency rankings, as the first sever is not able to handle additional programs. As used herein, a server being at or exceeding a “program capacity” refers generally to the server being deemed as having insufficient resources for deployment of a program. In examples, a server may be deemed as being at or exceeding program capacity if the server has a level of unutilized RAM, unutilized ROM, unutilized threads, or unutilized cores that is insufficient to support deployment of a program. In examples, deployment engine 206, as part of obtaining data indicative that a first server from the set of available servers has met or exceeded a program capacity, obtains data indicative of current usage of the first server. In examples, deployment engine 206 may obtain data indicative of current usage of the first server from the first server itself, via a network (e.g., link 116). In other examples, deployment engine 206 may obtain via a network (e.g., link 116) data indicative of current usage of the first server from an application or computing device that monitors performance characteristics of the first server.

Continuing with this example, deployment engine 206, responsive to subsequently obtaining data indicative that the first server has been relieved from a deployment of a program such that the server is no longer at or in excess of program capacity, may return the first server to the set of available servers. In this example, deployment engine 206 may cause the first server to once again be among the set of servers considered in the comparison of servers according to efficiency rankings, as the first sever again able to manage additional programs. In examples, the first server may be deemed as being under program capacity if the server has a level of unutilized RAM, unutilized ROM, unutilized threads, or unutilized cores that is sufficient to support deployment of a program.

In examples, efficiency rate engine 202 may recalculate the efficiency rates at predetermined times or intervals (e.g., every 15 minutes, every 30 minutes, etc.) and may determine an average efficiency rate for each of the servers of the set based on the average efficiency rates. In these examples, ranking engine 204 may rank the set of servers according to the average power consumption efficiency rates, and deployment engine 206 may deploy programs of the set of programs to servers of the set of servers in order of such efficiency rankings.

In examples, efficiency rate engine 202 may obtain a core performance factor for a server, or obtain a published performance index and a number of included cores for a server for determination of a core performance factor, over a link 116 via a networking protocol. In examples, deployment engine 206 may iteratively deploy programs from the set of programs to a set of available servers in order of efficiency ranking of the servers until the set of programs is deployed over a link 116 via networking protocol. In examples, the networking protocols may include, but are not limited to, Transmission Control Protocol/Internet Protocol (“TCP/IP”), HyperText Transfer Protocol (“HTTP”), and/or Session Initiation Protocol (“SIP”).

In the foregoing discussion of FIG. 2, engines 202-206 were described as combinations of hardware and programming. Engines 202-206 may be implemented in a number of fashions. Looking at FIG. 3 the programming may be processor executable instructions stored on a tangible memory resource 322 and the hardware may include a processing resource 324 for executing those instructions. Thus memory resource 322 can be said to store program instructions that when executed by processing resource 324 implement system 102 of FIG. 2.

Memory resource 322 represents generally any number of memory components capable of storing instructions that can be executed by processing resource 324. Memory resource 322 is non-transitory in the sense that it does not encompass a transitory signal but instead is made up of more or more memory components to store the relevant instructions. Memory resource 322 may be implemented in a single device or distributed across devices. Likewise, processing resource 324 represents any number of processors capable of executing instructions stored by memory resource 322. Processing resource 324 may be integrated in a single device or distributed across devices. Further, memory resource 322 may be fully or partially integrated in the same device as processing resource 324, or it may be separate but accessible to that device and processing resource 324.

In one example, the program instructions can be part of an installation package that when installed can be executed by processing resource 324 to implement system 102. In this case, memory resource 322 may be a portable medium such as a CD, DVD, or flash drive or a memory maintained by a server from which the installation package can be downloaded and installed. In another example, the program instructions may be part of an application or applications already installed. Here, memory resource 322 can include integrated memory such as a hard drive, solid state drive, or the like.

In FIG. 3, the executable program instructions stored in memory resource 322 are depicted as efficiency rate module 302, ranking module 304, and deployment module 306. Efficiency rate module 302 represents program instructions that when executed by processing resource 324 may perform any of the functionalities described above in relation to efficiency rate engine 202 of FIG. 2. Ranking module 304 represents program instructions that when executed by processing resource 324 may perform any of the functionalities described above in relation to ranking engine 204 of FIG. 2. Deployment module 306 represents program instructions that when executed by processing resource 324 may perform any of the functionalities described above in relation to deployment engine 206 of FIG. 2.

### Illustrative Example

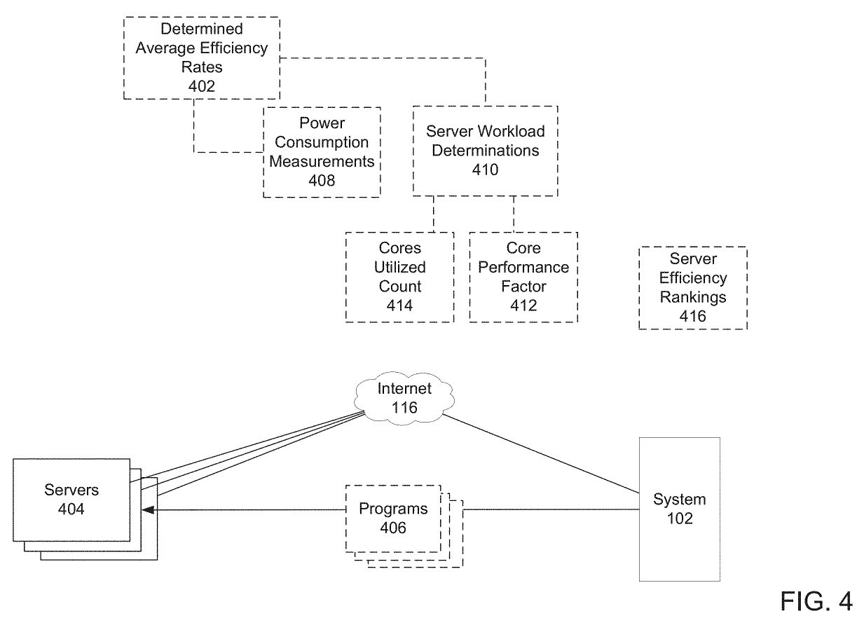

FIG. 4, in view of FIGS. 1 and 2, illustrates an example of a system 102 for enabling deployment of programs according to server efficiency rankings. In examples, system 102 may be hosted at a computer system such as server device 112 (FIG. 1) or distributed over a set of computer systems such as server system 114 (FIG. 1). Beginning at FIG. 4, in this example, system 102 determines an average efficiency rate 402 for each server of a set of servers 404 to be used for deployment of a set of programs 406. In this example, system 102 determines an average efficiency rate 402 for each of the servers of the set of servers 404 based upon measurements of power consumption 408 of the server during a time period, and based upon determined workloads 410 of the server during the time period. In this example, system 102 determines the workloads based upon a count of the number of server cores utilized 414 at the time of the power consumption measurement 408 and based upon a determined core performance factor 412.

In this example, system 102 determines an average efficiency rate 402 AE(x) for each server of the set of servers 404 utilizing the following formula:

$$AE ( x ) = \frac{At Px}{At Wx}$$

where AtPx is the average of t measurements of power consumption 408 by server x during a given time period, and AtWx is the average of determined workloads 410 of the server x during the time period of the t power consumption measurements. In this example, system 102 makes each workload determination for server x according to a formula

Wx=count of number of cores utilized(x)*core performance factor(x).

wherein core performance factor(x) for server x is a core performance factor determined according to a formula

$$core performance factor ( x ) = \frac{published performance index ( x )}{number of cores included in server ( x )} .$$

Continuing with the example of FIG. 4, system 102 may determine the core performance factor 412 for each server of the set of servers 404 based upon a published performance index for the server and based upon a number of cores included within or incorporated within the first server. System 102 may, for the each server of the set of servers 404, obtain the published performance index and the number of cores included within or incorporated within the server via the internet 116 or another network from a manufacturer website, server provider website, and/or a technology news website. In a particular example, the manufacturer website, server provider website, and/or a technology news website is hosted by a computer system distinct from a computer system that hosts system 102.

Continuing with the example of FIG. 4, system 102 ranks each of the servers of the set of servers with an efficiency ranking 416 that is based upon the determined average efficiency rates 402. System 102 in turn causes iterative deployment of the set of programs 406 from the set of programs 406 to a set of available servers 422, in order of efficiency ranking 416 of the servers, until each of the programs of the set of programs 406 is deployed.

Operation:

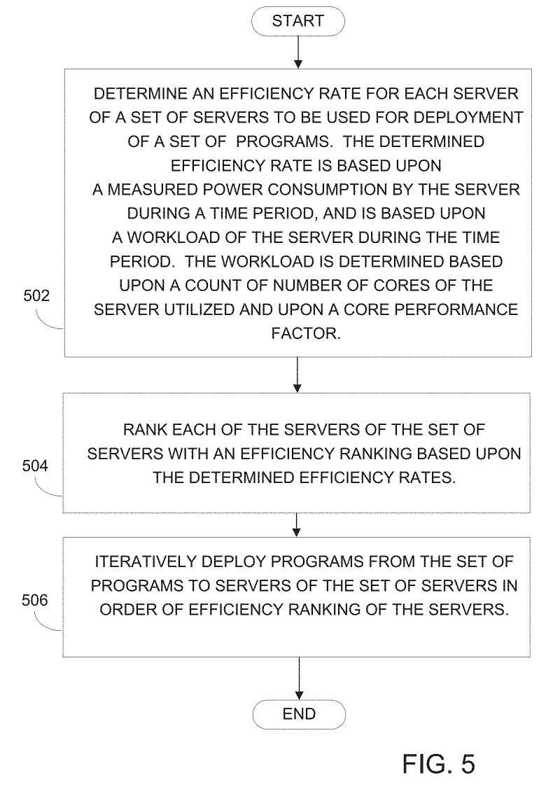

FIG. 5 is a flow diagram of implementation of a method to enable deployment of programs according to server efficiency rankings. In discussing FIG. 5, reference may be made to the components depicted in FIGS. 2 and 3. Such reference is made to provide contextual examples and not to limit the manner in which the method depicted by FIG. 5 may be implemented. An efficiency rate is determined for each server of a set of servers to be used for deployment of a set of programs. The efficiency rate is determined based upon

a measured power consumption by the server during a time period, and based upon
a workload of the server during the time period. The workload of the server during the time period is determined based upon a count of number of cores of the server utilized and upon a core performance factor (block 502). Referring back to FIGS. 2 and 3, efficiency rate engine 202 (FIG. 2) or efficiency rate module 302 (FIG. 3), when executed by processing resource 324, may be responsible for implementing block 502.

Each of the servers of the set of servers is ranked with an efficiency ranking based upon the determined efficiency rates (block 504). Referring back to FIGS. 2 and 3, ranking engine 204 (FIG. 2) or ranking module 304 (FIG. 3), when executed by processing resource 324, may be responsible for implementing block 504.

Programs from the set of programs to servers of the set of servers are iteratively deployed in order of efficiency ranking of the servers (block 506). Referring back to FIGS. 2 and 3, deployment engine 206 (FIG. 2) or deployment module 306 (FIG. 3), when executed by processing resource 324, may be responsible for implementing block 506.

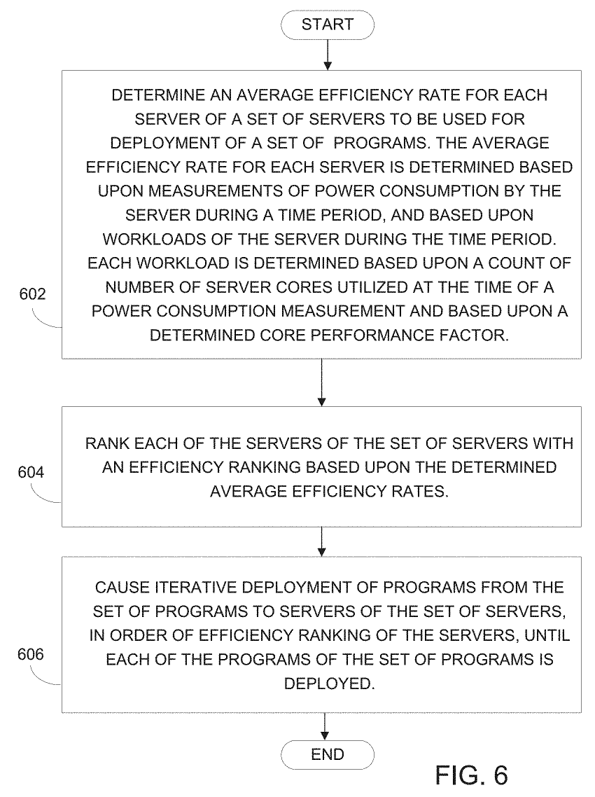

FIG. 6 is a flow diagram of implementation of a method to enable deployment of programs according to server efficiency rankings, the rankings based upon average efficiency ratings. In discussing FIG. 6, reference may be made to the components depicted in FIGS. 2 and 3. Such reference is made to provide contextual examples and not to limit the manner in which the method depicted by FIG. 6 may be implemented. An average efficiency rate is determined for each server of a set of servers to be used for deployment of a set of programs. The average efficiency rate is determined for each server based upon measurements of power consumption by the server during a time period, and based upon workloads of the server during the time period. Each workload is determined based upon a count of number of server cores utilized at the time of a power consumption measurement and based upon a determined core performance factor (602). Referring back to FIGS. 2 and 3, efficiency rate engine 202 (FIG. 2) or efficiency rate module 302 (FIG. 3), when executed by processing resource 324, may be responsible for implementing block 602.

Each of the servers of the set of servers is ranked with an efficiency ranking based upon the determined average efficiency rates (block 604). Referring back to FIGS. 2 and 3, ranking engine 204 (FIG. 2) or ranking module 304 (FIG. 3), when executed by processing resource 324, may be responsible for implementing block 604.

Iterative deployment of programs from the set of programs is caused to servers of the set of servers, in order of efficiency ranking of the servers, until each of the programs of the set of programs is deployed (block 606). Referring back to FIGS. 2 and 3, deployment engine 206 (FIG. 2) or deployment module 306 (FIG. 3), when executed by processing resource 324, may be responsible for implementing block 606.

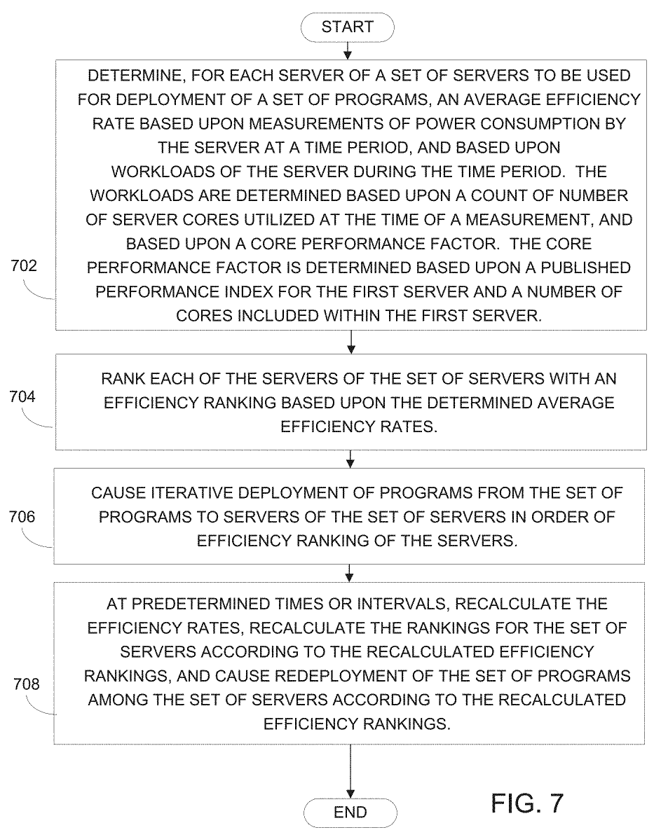

FIG. 7 is a flow diagram of implementation of a method to deploy programs according to server efficiency rankings, with redeployments of programs according to recalculated efficiency rankings. In discussing FIG. 7, reference may be made to the components depicted in FIGS. 2 and 3. Such reference is made to provide contextual examples and not to limit the manner in which the method depicted by FIG. 7 may be implemented. Determine, for each server of a set of servers to be used for deployment of a set of programs, an average efficiency rate based upon measurements of power consumption by the server at a time period, and based upon workloads of the server during the time period. The workloads are determined based upon a count of number of server cores utilized at the time of a measurement, and based upon a core performance factor determined based upon a published performance index for the first server and a number of cores included within the first server (1002). Referring back to FIGS. 2 and 3, efficiency rate engine 202 (FIG. 2) or efficiency rate module 302 (FIG. 3), when executed by processing resource 324, may be responsible for implementing block 702.

Rank each of the servers of the set of servers with an efficiency ranking based upon the determined average efficiency rates (block 704). Referring back to FIGS. 2 and 3, ranking engine 204 (FIG. 2) or ranking module 304 (FIG. 3), when executed by processing resource 324, may be responsible for implementing block 704.

Cause iterative deployment of programs from the set of programs to servers of the set of servers in order of efficiency ranking of the servers (block 706). Referring back to FIGS. 2 and 3, deployment engine 206 (FIG. 2) or deployment module 306 (FIG. 3), when executed by processing resource 324, may be responsible for implementing block 706.

At predetermined times or intervals, recalculate the efficiency rates, recalculate the rankings for the set of servers according to the recalculated efficiency rankings, and cause redeployment of the set of programs among the set of servers according to the recalculated efficiency rankings (block 708). Referring back to FIGS. 2 and 3, efficiency rate engine 202 (FIG. 2), ranking engine 204 (FIG. 2), and deployment engine 206 (FIG. 2), or efficiency rate module 302 (FIG. 3), ranking module 304 (FIG. 3), and deployment module 306 (FIG. 3), when executed by processing resource 324, may be responsible for implementing block 708.

### CONCLUSION

FIGS. 1-7 aid in depicting the architecture, functionality, and operation of various examples. In particular, FIGS. 1, 2 and, 3 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is a non-transitory storage media that can contain, store, or maintain programs and data for use by or in connection with the instruction execution system. The term “non-transitory” is used to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 5, 6 and 7 show specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

The present disclosure has been shown and described with reference to the foregoing examples. It is to be understood, however, that other forms, details and examples may be made without departing from the spirit and scope of this application that is protected by the following claims. The features disclosed in this specification (including accompanying claims, abstract and drawings), and/or the blocks or stages of a method or process so disclosed, may be combined in any combination, except combinations where at least some of such features, blocks and/or stages are mutually exclusive.

What is claimed is:

1. A system to deploy programs among servers according to efficiency rankings, comprising:
an efficiency rate engine, to determine an efficiency rate for each server of a set of servers to be used for deployment of a set of programs, wherein the determined efficiency rate is based upon
a measured power consumption by the server during a time period, and
a workload of the server during the time period, the workload determined based upon a count of a number of cores of the server utilized and upon a core performance factor;
a ranking engine, to rank each of the servers of the set of servers with an efficiency ranking based upon the determined efficiency rates; and
a deployment engine, to iteratively deploy programs from the set of programs to servers of the set of servers in order of efficiency ranking of the servers.

2. The system of claim 1, wherein the count of number of cores of the server utilized is a count at the time of the measurement of power consumption.

3. The system of claim 1, wherein the count of number of cores of the server utilized is a count with a defined time proximity of the measurement of power consumption measurement.

4. The system of claim 1, wherein the core performance factor is a value obtained from at least one of a manufacturer website, a provider website, and a technology news website.

5. The system of claim 1, wherein the efficiency rate engine is to determine the core performance factor for a first server of the set of servers based upon a published performance index for the first server and a number of cores included within the first server.

6. The system of claim 5, wherein at least one of the published performance index for the first server and the number of cores included within the first server is a value obtained from at least one of a manufacturer website, a provider website, and a technology news website.

7. The system of claim 1, wherein the efficiency rate engine is to recalculate the efficiency rates at predetermined times or intervals and is to determine an average efficiency rate for each of the servers of the set, and the ranking engine is to rank the set of servers according to the average power consumption efficiency rates, and the deployment engine is to deploy programs of the set of programs in order of efficiency ranking of the servers according to the rankings.

8. The system of claim 1, wherein the efficiency rate engine is to determine the efficiency rate for each server of the set of servers at time or during a period that the server is being used for deployment of a program.

9. The system of claim 1, wherein the deployment engine is to iteratively deploy programs from the set of programs until each of the programs of the set of programs is deployed.

10. The system of claim 1, wherein, responsive to obtaining data indicative that a first server from the set of servers is at or is in excess of a program capacity, the deployment engine removes the first server from the set of servers, and wherein, responsive to subsequently obtaining data indicative that the first server has been relieved from a deployment of a program such that the server is no longer at or in excess of program capacity, the deployment engine returns the first server to the set of servers.

11. The system of claim 10, wherein obtaining data indicative that a first server from the set of servers has met or exceeded a program capacity includes obtaining data indicative of current usage of the first server.

12. A memory resource storing instructions that when executed cause a processing resource to deploy programs among servers utilizing efficiency rankings, the instructions comprising:
an efficiency rate module that when executed causes the processing resource to determine an average efficiency rate for each server of a set of servers to be used for deployment of a set of programs, the average efficiency rate for each server based upon
measurements of power consumption by the server during a time period, and
workloads of the server during the time period, each workload determined based upon a count of number of server cores utilized at the time of a power consumption measurement and based upon a determined core performance factor;
a ranking module that when executed causes the processing resource to rank each of the servers of the set of servers with an efficiency ranking based upon the determined average efficiency rates; and
a deployment module that when executed causes the processing resource to cause iterative deployment of programs from the set of programs to servers of the set of servers, in order of efficiency ranking of the servers, until each of the programs of the set of programs is deployed.

13. The memory resource of claim 12, wherein the efficiency rate module when executed causes the processing resource to determine the core performance factor for a first server of the set of servers based upon obtained data indicative of a published performance index for the first server and a number of cores included within the first server.

14. A method to deploy programs in consideration of measurements of server power consumption, comprising:
determining, for each server of a set of servers to be used for deployment of a set of programs, an average efficiency rate based upon
measurements of power consumption by the server at a time period; and
workloads of the server during the time period, the workloads determined based upon a count of number of server cores utilized at the time of a measurement, and based upon a core performance factor determined based upon a published performance index for the first server and a number of cores included within the first server;
ranking each of the servers of the set of servers with an efficiency ranking based upon the determined average efficiency rates;
causing iterative deployment of programs from the set of programs to servers of the set of servers in order of efficiency ranking of the servers; and
at predetermined times or intervals, recalculating the efficiency rates, recalculating the rankings for the set of servers according to the recalculated efficiency rankings, and causing redeployment of the set of programs among the set of servers according to the recalculated efficiency rankings.

15. The method of claim 14, further comprising, responsive to obtaining data indicative that a first server from the set of servers has met or exceeded a program capacity, removing the first server from the set of servers, and responsive to subsequently obtaining data indicative that the first server has been relieved from a deployment of a program such that the server is no longer or exceeds at program capacity, returning the first server to the set servers.
